(19) United States
(12) Patent Application Publication
(10) Pub. No.: US 2005/0245419 A1
(43) Pub. Date: Nov. 3, 2005

(54) Detergent composition

(75) Inventors: Marcus Guzmann, Muehlhausen (DE); Roger Kaiser, Ludwigshafen (DE); Ralf Wiedemann, Ludwigshafen (DE)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofddorp (NL)

(21) Appl. No.: 10/519,314

(22) PCT Filed: Jun. 27, 2003
(86) PCT No.: PCT/GB03/02752

§ 371 Date: Dec. 23, 2004

(30) Foreign Application Priority Data
Jun. 28, 2002 (GB) 0214991.2

(51) Int. Cl. C11D 17/00

(52) U.S. Cl. 510/407

(57) ABSTRACT

The present invention comprises a detergent composition. The composition comprises a gel having a first colour and primary particles having a second colour. Radiation emitted by the gel interacts with radiation emitted by the primary particles such that at least a portion of the composition has a third colour.

The present invention relates to a detergent composition, more particularly to a detergent composition comprising a gel having a first colour and particles having a second colour, wherein radiation emitted by the gel interacts with that emitted by the particles to give a third coloration to at least part of the composition.

It is desirable to colour detergent compositions, especially liquid detergent compositions, to increase the consumer appeal of such formulations. However, the colouring needs to be done very carefully to avoid negative side effects.

One problem of colouring detergent compositions is that colouring agents are generally fairly complex species, having a particular chemical arrangement to achieve the colouring affect. Often these chemical arrangements are sensitive and cannot tolerate harsh environments. As detergent compositions usually contain one or more aggressive components such as bleach, achieving the desired colour with a, for example, bleach stable colouring agent can be difficult.

A further problem is that although it is desirable to colour the detergent composition to make it more appealing to a consumer the imparting of colour to items being cleaned and/or the cleaning apparatus which use the detergent is used is to be avoided. This problem has been found to be especially prevalent in the area of dishwashing, especially with plastic dishes/utensils which can readily and adopt a colouring agent.

Additionally the colouring agent must be non-toxic to the user so that the items being cleaned do not lead to an undesirable skin and/or other medical reaction.

Together with the factors above cost is also an important consideration to the manufacturers of the detergents. A balance must be struck between the factors listed above, cost and the effect of the colouring agent. In this regard it is to be noted that ever increasingly more complex colours are perceived to be necessary to achieve the right level of customer appeal. Usually complex colours, e.g. secondary colours such as orange, require more than one colouring agent to achieve the desired colour. This implies that not only must each of the factors above be addressed for each component of the complex colour but also the cost of the colouring increases relating to the number of primary or base colours required.

It is recognised that there is a need to achieve colouring of detergent compositions with complex colours with the reduction of cost/inconvenience caused by the problems above. The present invention obviates the problems described above.

According to a first aspect of the present invention there is provided a detergent composition comprising a gel having a first colour and primary particles having a second colour, wherein radiation emitted by the gel interacts with radiation emitted by the primary particles such that at least a portion of the composition has a third colour.

According to a second aspect of the present invention there is provided a semi-opaque detergent composition comprising a gel having a first colour and primary particles having a second colour, wherein radiation emitted by the gel interacts with radiation emitted by the primary particles such that at least a portion of the composition has a third colour.

According to a third aspect of the present invention there is provided a detergent composition comprising a gel containing primary particles having a first colour and secondary particles having a second colour, wherein radiation emitted by the primary particles interacts with radiation emitted by the secondary particles such that at least a portion of the composition has a third colour.

According to a fourth aspect of the present invention there is provided a detergent composition comprising a gel having a first colour containing primary particles having a second colour and secondary particles having a third colour, wherein radiation emitted by the primary particles interacts with the secondary particles and the radiation emitted by the gel such that at least a portion of the composition has a fourth colour.

The term “radiation” most preferably refers to visible light. In this context “emitted” is preferably taken to mean the component (of visible light) which is not absorbed by the component referred to in the composition. For example, for a yellow gel it is hereby assumed that the gel appears yellow because all of the frequencies of visible light are absorbed by one or both of the colouring agent and the gel itself, with the exception of the yellow component of visible light which is emitted.

The secondary particles are preferably in the form of emulsion particles (micelles), suspended particles or gas bubbles, most preferably air bubbles.

It is preferred that the secondary particles are at least partially reflective.

Generally the secondary particles have a particle size of less than 50 μm, more preferably less than 40 μm, more preferably less than 30 μm, more preferably less than 20 μm, more preferably less than 10 μm and most preferably less than 1 μm.

It have now surprisingly been found that in compositions in accordance with the four aspects of the invention the colour of a coloured gel can be significantly influenced by adding coloured primary particles (hereafter referred to as particles) to such a gel. This leads to the interesting and surprising effect that the floating particle colour interacts with the base colour of the gel. Using this effect an alteration or an intensification of the base colour of the gel can be achieved without incurring the problems normally associated with colouring a detergent composition. For example detergent compositions can now be formulated with complex colours yet with the avoidance of the risk of, for example, increased plastic staining in the washing process.

Moreover, new colours, like the normally difficult and complex to achieve orange can now be attained by the interaction of the coloured particle with the coloured gel. To achieve an orange coloration one of the gel or the particle must be coloured red with the other component coloured yellow, e.g. a yellow gel with red particles dispersed therein.

It is important to note that this effect is completely reversible. Namely when the coloured particles are removed the original colour of the gel is recovered. This effect is taken as evidence that the change in colour is not due to leaking of colour from the particle or friability of the particle leading to the distribution of dye particles in the gel.

To achieve the effect of colour alteration/intensification it is most preferred that the gel has a transmittance of from 30 to 90%, more preferably from 40 to 90% and most preferably from 50 to 90%. It has been found that transmission ratio of light through the gel should not be so low that the particles can not be seen in the product, otherwise no colour alteration effect is observed. Without wishing to be bound by theory it is proposed that the gel transmittance in the preferred ranges specified above creates a reflection of light. It is considered that this reflection of light from one or both of the gel and/or the particles therein causes and interaction of the light emitted by both components leading to the colour effect.

The transmittance is most preferably measured by the ELVORS method. The ELVORS transmission method follows below.

A light source (500 W, Duwi GmbH, Mod. 93024) is installed facing a lux meter (Elvors LM-1010) at a distance of 130 cm. A sample is located at 4 cm distance from the photocell. The sample has a thickness of 5 mm and covers an area of 25 cm². The value measured by the apparatus is recorded and a transmission ratio is calculated with the following formula:

$$Transmission Ratio = \frac{Measured value with the composition}{Measured value with pure water} * 100$$

The particles preferably have a migration speed in the gel of less than one centimetre per month.

As a result of the low mobility of the particles, the particles once dispersed in the gel, remain dispersed therein, even after long periods of storage. This helps to ensure that the colour effect caused by the interaction of the radiation emitted from these particles and the other components of the composition is evenly distributed and constant across the composition. Also the problems of particle interaction and damage, as a result of particle congregation at or near an upper or lower portion of the gel have been largely overcome.

The composition preferably comprises a detergent active which is at least partially encapsulated within the particles. The particles are preferably water-soluble, comprising a water-soluble encapsulating agent.

The particles remain evenly dispersed, even over prolonged periods of storage, the user can be sure when measuring/dispersing an amount of the detergent gel, that it contains the correct (rather than an excessive or insufficient) amount of particles (and associated detergent active). Furthermore the correct dispense/measurement may be achieved without the need to shake or otherwise agitate the gel which could otherwise cause detrimental particle deterioration.

Thus the present invention has been found to provide an detergent active containing detergent gel composition which displays surprisingly good detergent active stability during storage (which is especially important for sensitive components such as enzymes), whilst also ensuring a quick and efficient release of detergent active in use.

Preferably the particles comprise at least 0.3 wt % of the composition, more preferably at least 0.6 wt % of the composition and most preferably at least 0.9% of the detergent composition.

Preferably the migration speed of the particles is less than 0.7 cm per month and most preferably less than 0.4 cm per month.

Without wishing to be bound by theory the migration speed of the particles may be measured by the following preferred, yet non-limiting method.

The particles are dispersed in the gel and the gel is placed in a closed glass bottle (capacity 50 ml, width 3.5 cm). A picture is taken (Canon Powershot 30S camera, with the distance lens-bottle being 50 cm). The bottle is stored for 30 days at 25° C. A second picture is taken from the glass bottle and the locations of the particles are compared. Changes of location (Migration distance of particle on picture=Dₚ) are recorded in cm. The migration distance Dr of an individual particle is determined according to the following formula, which overcomes any parallax error introduced by the picture taking process.
Dᵣ=Hᵣ×Dₚ/Hₚ
Hₚ=Bottle height on picture
Hᵣ=Real bottle height
Dₚ=Migration distance of particle on picture
Dᵣ=Real migration distance of particle

The result is taken from the average migration distance of 20 particles.

The preferred migration speed of the particles within the gel is preferably achieved by a combination of gel viscosity, gel density and particle density.

The gel preferably has a viscosity of greater than 4000 mPas, preferably greater than 6000 mPas, most preferably more than 10000 mPas. The viscosity was measured with a Brookfield RVT, spindle 27, 2.5 rpm at 25° C.

In order to achieve this viscosity the gel preferably contains a thickening agent. A preferred example of a thickening agent is polyacrylic acid.

The gel preferably has a density of more than 1.1 g/cm³, more preferably more than 1.2 g/cm³ and most preferably more than 1.4 g/cm³.

The gel is preferably substantially water free (having a water content of less than 5%).

Alternatively the gel may have a higher water content with a high ionic strength to prevent the particles from deteriorating in storage. Preferably the water content of the gel is from 5 to 65%, more preferably 20 to 60% and most preferably from 35 to 50%; the high ionic strength is preferably provided by a salt content which comprises at least 70%, more preferably at least 80% and most preferably at least 90% of the solid content (the non-aqueous component) of the gel.

Preferred examples of salts include phosphates, (such as tripolyphosphates) citrates and sulphates. Most preferably the salts are alkali metal salts, especially sodium and potassium.

Preferably the detergent active comprises one or more of an enzyme, a bleach activator/catalyst and/or a fragrance. Most preferably the detergent active is an enzyme.

As pure enzymes typically have a dark brown colour, which is usually not appealing to a consumer, the pigment or dye included in the particles makes them more aesthetically appealing.

The composition may comprise a plurality of enzymes. A portion of each enzyme may be disposed within the water-soluble particles.

An advantage of the present invention is that it allows formulation of a detergent gel composition containing two or more antagonistic enzymes. In this context antagonistic implies that one enzyme would upon contact ordinarily cause/be involved in the deterioration of one or more other enzymes, possibly together with itself, present in the detergent gel.

This may be achieved by separate encapsulation of one or more of the enzymes within particles in the detergent gel. Namely, (explained with reference to a 2-enzyme containing system) two options are available. In the first option each enzyme may be encapsulated so that whilst the particles are intact contact is not possible. In the alternative, only one of the enzymes need be encapsulated to prevent contact.

In the case where a first enzyme is deteriorated by a second it is preferably to contain the first enzyme in the detergent gel and the second enzyme within the particles. In this arrangement the first susceptible enzyme has an opportunity in use after release to carry out its function, before the second enzyme is released from the water-soluble particle, i.e. before the second enzyme is able to detrimentally affect the first enzyme.

For example starch digesting enzymes such as amylase are usually deteriorated by protein digesting enzymes (proteases) on long-term storage. To address this problem, and using the present invention the amylase may be contained in the gel and the protease within the particles. This concept could of course also be applied in the reverse, wherein the protease is in the gel and amylase is in the particles.

Furthermore due to the nature of the gel an enzyme released prematurely from, for example, a leaking particle is kinetically hindered by the viscous nature of the gel. Thus destructive interaction with its antagonist is at least partially hindered.

To further enhance the stability of the encapsulated enzyme a stabilising aid may be present.

Without wishing to be bound by theory it is proposed that the stabilising aid enhances the stability of the enzyme by “blocking” the active site thereof whilst the enzyme is encapsulated in the particle. As soon as the composition is dispersed in use (e.g. in a wash liquor) the stabilising aid is preferably dispersed in the liquor. Thus the active site of the enzyme is free to act.

Preferred examples of stabilisers include calcium salts, sugars and starches.

The composition preferably comprises an amylase and/or a protease, to aid soil removal. Any of the encapsulation scenarios described in the paragraphs above is contemplated when both enzymes are present.

The particles are non-soluble in the gel during storage but dissolve when the gel is exposed to the conditions of a laundry or dishwashing process. A typical dilution of the gel containing such particles in such process is 15-200 g, more preferred 20-150 g most preferred 25-50 g of gel in a wash water amount of 4-15 L, more preferred 4-8 L.

The particles comprise a water-soluble encapsulating agent. Water-soluble is herein defined when greater than 90% of 1 g of such material (in granular form having a particle size from 50-200 μm) dissolves after 40 min in a beaker containing 1 L of deionised water at 40° C. which is stirred with a stirrer revolving at 200 r.p.m.

The encapsulating agent may comprise a coating for the particles. Alternatively the encapsulating agent may comprise a portion of the core of the particle.

In the first case (where the encapsulating agent is a coating) the encapsulating agent may comprise 2-15% by weight, more preferably 2-10% by weight of the particle.

In the second case (where the encapsulating agent comprises a portion of the core of the particle) it is preferred that the encapsulating agent defines a matrix, within which any other components of the particle may be disposed. In this case the encapsulating agent may comprise at least 10% by weight and more preferably at least 20% by weight of the particle.

Most preferably the encapsulating agent comprises a coating.

The encapsulating agent may contain a plasticiser. Preferred plasticisers include polyglycols and non-ionic surfactants.

Preferably the encapsulating agent is a cellulose derivative or a polyvinylalcohol derivative or a combination thereof.

The preferred density of the particles is expressed relative to that of the gel. The gel and the particles have a preferred difference in density no greater than 0.9 g/cm³, more preferably no greater than 0.6 g/cm³ and most preferably no greater than 0.3 g/cm³.

In order to achieve the desired density difference between the gel and the particles, the particles may incorporate a density aid. Preferred examples of density aids include titanium dioxide and calcium salts.

The particles have a granule size distribution in which more than 80% of the particles are of the particle size from 50-1000 μm, more preferably from 200-800 μm and most preferably from 400-700 μm.

The particles preferably have a spherical shape. Most preferably the particles are dispersed evenly throughout the gel composition. When being dispersed, it will be appreciated that low shear methods are employed.

The particles may contain other detergent constituents, which are non-aggressive to the enzyme, such as a citrate or a phosphate (e.g. sodium or potassium tripolyphosphate) salt.

The detergent composition is intended for use in dishwashing (both manual and automatic, most preferably automatic) and/or laundry applications.

The product is preferably packed in a water-soluble packaging. Such packaging may be produced by thermoforming of a foil and then sealing of the formed and filled container; vertical form-fill-seal processes or injection moulding of compartments and subsequent filling and closing of such compartments.

The invention is now illustrated with reference to the following non-limiting Examples.

### EXAMPLES

Coloured protease (Prosperase) and amylase particles were made using a sugar core material mixed with the enzymes to produce prills. The prills were then coated with hydroxypropylmethylcellulose (alternatively polyvinylalcohol or mixtures of the two were used) which contained plasticiser (polyglycol or a nonionioc surfactant) and pigment dye (e.g. the red dye Sicovit Cochenillerot 80 E 124 (BASF)) or the blue dye (Direct Blue 086 (BASF)). The resulting particles were comprised of sugar (40-70%), enzyme (2-20%) film forming water-soluble material (2-10%), plasticiser (1-5%), TiO₂ (2-5%) dye (0.13-0.22%). Standard prill making and coating technologies provided by e.g. equipment as produced by Glatt were used to make the particles. The particles produced had a particle size wherein 80% of the particles had a diameter in the range 200-600 μm.

A coloured gel was made up having the following composition:

| Component | Wt % |
|---|---|
| Dehardened Water | To 100 |
| Sulphuric acid (50%)* | 0.175 |
| Dye | 0.0025/0.0017 |
| Polyacrylic acid (thickener) | 0.800 |
| Sodium citrate | 30.000 |
| Potassium tripolyphosphate | 30.000 |
| Properase particle | 0.63 |
| Amylase particle | 0.340 |
| Perfume | 0.300 |

*Sulphuric acid is added to water to facilitate the dispersion of the thickener. After dispersion of thickener all other ingredients are added.

### Example 1

A gel was made up as above. The gel was coloured yellow with yellow dye Basovit Yellow 133E (BASF). The enzyme particles were coloured red with Sicovit Cochenillerot 80 E 124.

The gel (50 cm³) was exhibited in front of a panel of ten people (in a glass container), for colour assessment purposes. For the test a container of the coloured gel with no added particles was also available.

All ten of the panel indicated that the colour of the overall composition had altered from yellow to orange. This serves to illustrate how a complex colour (such as orange) may be created using a formulation in accordance with the invention, i.e. the red colour of the particles interacts with the yellow colour of the gel to give an orange colour overall.

### Example 2

A gel was made up as above. The gel was coloured blue with blue dye Basic Acid Blue 762 (BASF). The enzyme particles were coloured blue with Direct Blue 086.

The gel was exhibited in front of a panel of ten people for colour assessment purposes (as in Example 1). For the test a container of the coloured gel with no added particles was also available.

All ten of the panel indicated that the colour of the overall composition had altered to a more intense deep blue colour. This serves to illustrate how the intensity of a colour (such as blue) may be altered using a formulation in accordance with the invention.

### Example 3

A number of gel formulation were made up as shown in the Table I.

TABLE 1

| | For- | | | | | |
|---|---|---|---|---|---|---|
| | mu- | | | | | |
| | la | Formula | Formula | Formula | Formula | Formula |
| | 1 | 2 | 3 | 4 | 5 (C) | 6 (C) |
| Potassium | 30.00 | 30.00 | 30.00 | 25.00 | 50.70 | — |
| tripolyphosphate | | | | | | |
| Sodium | — | — | — | — | — | 19.89 |
| tripolyphosphate | | | | | | |
| Sodium citrate | 30.00 | 30.00 | 30.00 | 25.00 | — | — |
| Potassium | — | — | — | 10.00 | — | — |
| citrate | | | | | | |
| Sodium | — | — | — | — | — | 32.00 |
| disilicate | | | | | | |
| Enzymes | 0.97 | 0.97 | 2.30 | 0.71 | — | 1.20 |
| Polyacrylate | — | 0.80 | 0.60 | 0.08 | 0.80 | — |
| Tallow alcohol | — | — | — | — | — | 7.90 |
| Nonionic | — | — | — | — | — | — |
| surfactant | | | | | | |
| (EO/PO) | | | | | | |
| Xanthan Gum | — | — | — | — | — | — |
| Sokalan CP 5 | | | | 0.50 | — | — |
| KOH | — | — | — | — | — | — |
| Phosphoric acid | 0.10 | — | — | — | — | — |
| Sulphuric acid | — | 0.10 | 0.10 | 0.10 | — | — |
| Preservative | | | | — | 0.10 | — |
| Colorant | 0.02 | 0.05 | 0.05 | 0.02 | 0.02 | 0.02 |
| Water | to | to 100 | to 100 | to 100 | to 100 | to 100 |
| | 100 | | | | | |

Formulae 1-4 are in accordance with the invention with Formulae 5-6 being used as comparative examples.

Each formula was tested for a transmittance ratio using the ELVORS method outlined above.

The results of this test are shown in Table 2.

TABLE 2

| Formula | Transmittance Ratio % |
|---|---|
| 1 | 40-90 |
| 2 | 40-90 |
| 3 | 40-90 |
| 4 | 40-90 |
| 5 (C) | 95 |
| 6 (C) | 7 |

The gels according to the Formulae 1-4 show a strong change of colour when coloured particles are added. Gels according to the comparative Formulae 5 and 6 do not show this change of colour, as the transmittance ratio for formula 5 is too high and the transmittance ration for formula 6 is too low.

This Example illustrates the need for a transmittance ratio which is neither too high or too low to produce a colour effect.

1. A detergent composition comprising a gel having a first colour and primary particles having a second colour, wherein radiation emitted by the gel interacts with radiation emitted by the primary particles such that at least a portion of the composition has a third colour.

2. A semi-opaque detergent composition comprising a gel having a first colour and primary particles having a second colour, wherein radiation emitted by the gel interacts with radiation emitted by the primary particles such that at least a portion of the composition has a third colour.

3. A detergent composition comprising a gel containing primary particles having a first colour and secondary particles having a second colour, wherein radiation emitted by the primary particles interacts with radiation emitted by the secondary particles such that at least a portion of the composition has a third colour.

4. A detergent composition comprising a gel having a first colour containing primary particles having a second colour and secondary particles having a third colour, wherein radiation emitted by the primary particles interacts with the secondary particles and the radiation emitted by the gel such that at least a portion of the composition has a fourth colour.

5. A composition according to claim 3, wherein the secondary particles are in the form of emulsion particles (micelles), suspended particles or gas bubbles (preferably air).

6. A composition according to claim 3, wherein the secondary particles are at least partially reflective.

7. A composition according to claim 3, wherein the secondary particles have a particle size of less than 50 μm.

8. A composition according to claim 1, wherein the composition has a transmittance of from 30 to 90%.

9. A composition according to claim 1, comprising a detergent active which is at least partially encapsulated within the primary particles.

10. A composition according to claim 9, wherein the primary particles are water soluble and comprise a water-soluble encapsulating agent.

11. A composition according to claim 10, wherein the water soluble particles comprise at least 0.3 wt % of the detergent composition.

12. A composition according to claim 9, wherein the migration speed of the particles is less than 1.0 cm per month.

13. A composition according to claim 1, wherein the gel has a viscosity greater than 4,000 mPas.

14. A composition according to claim 1, wherein the gel contains a thickening agent, preferably polyacrylic acid.

15. A composition according to claim 1, wherein the gel has a density of greater than 1.1 g/cm³.

16. A composition according to claim 1, wherein the gel is substantially water free having a water content of less than 5%.

17. A composition according to wherein the gel has a water content of from 5 to 65%.

18. A composition according to claim 17, wherein the composition has a salt content of at least 70%.

19. A composition according to claim 18, wherein the salt is a phosphate, citrate or sulphate salt.

20. A composition according to claim 11, wherein the detergent active comprises one or more of an enzyme, a bleach activator/catalyst or a fragrance.

21. A composition according to claim 1, wherein the particles contain a stabilising aid for the enzyme.

22. A composition according to claim 10, wherein the encapsulating agent comprises a coating for the particles.

23. A composition according to claim 22, wherein the encapsulating agent comprises 2 to 15% of the particle.

24. A composition according to claim 10 wherein the encapsulating agent comprises a portion of the core of the particle.

25. A composition according to claim 24, wherein the encapsulating agent comprises at least 10% of the particles.

26. A composition according to claim 10, wherein the encapsulating agent contains a plasticiser.

27. A composition according to claim 26, wherein the plasticiser is a polyglycol or a nonionic surfactant.

28. A composition according to claim 26, wherein the encapsulating agent is a cellulose derivative, a polyvinyl alcohol or an admixture thereof.

29. A composition according to claim 1, wherein the gel and the primary particles have a difference in density of no greater than 0.9 g/cm³.

30. A composition according to claim 29, wherein the primary particles contain a density aid.

31. A composition according to claim 1, wherein more than 80% of the primary particles have a particle size from 50 to 1,000 micrometres.

32. A composition according to claim 1 for use in dishwashing or and/or laundry applications.

33. A composition in accordance with claim 1, wherein the composition is disposed in a pouch of polyvinylalcohol.

34. A method of dishwashing or laundry comprising the use of a detergent composition in accordance with claim 1.
